(19) United States
(12) Patent Application Publication
(10) Pub. No.: US 2024/0062939 A1
(43) Pub. Date: Feb. 22, 2024

(54) TRUE RANDOM NUMBER GENERATOR

(71) Applicant: Fudan University, Shanghai (CN)

(72) Inventors: Jiang XIAO, Shanghai (CN); Xiheng CHEN, Shanghai (CN)

(21) Appl. No.: 18/138,340

(22) Filed: Apr. 24, 2023

(30) Foreign Application Priority Data
Aug. 19, 2022 (CN) 202211003034.7

(51) Int. Cl. H01F 10/32; G06F 7/58

(52) U.S. Cl. CPC H01F 10/3268; G06F 7/588

(57) ABSTRACT

An apparatus includes a magnetic tunnel junction (MTJ), a magnetic field generator, and a detection circuit. The MTJ includes a free layer configured to switch between a first equilibrium state and a second equilibrium state, a reference layer, and an insulator layer sandwiched between the free layer and the reference layer. The magnetic field generator is configured to apply a magnetic field to the free layer to reduce a barrier between the first equilibrium state and the second equilibrium state. The detection circuit is configured to detect a resistance state of the MTJ, and generate a bit value for a random number based on the resistance state of the MTJ.

### CROSS-REFERENCE TO RELATED APPLICATION

This application claims priority to Chinese Application No. 202211003034.7, filed Aug. 19, 2022, the entire content of which is incorporated herein by reference.

### TECHNICAL FIELD

The present disclosure relates to random number generation and, more particularly, to a true random number generator (TRNG) based on magnetic tunnel junction (MTJ), and a method of generating true random numbers using the MTJ-based TRNG.

### BACKGROUND

Random numbers are essential in many aspects of modern information technology, especially in cryptographic systems, and increasingly more important in various stochastic computing algorithms or paradigms, such as the Monte Carlo simulation, neural networks, and more recently probabilistic computing, and etc. At present, random numbers are most commonly generated using pseudorandom number generators (PRNGs) via mathematical algorithms, but the randomness of such pseudorandom numbers is often questionable and suffers security risks. True random number generators (TRNGs), on the other hand, are usually based on some stochastic physical processes existing in nature, such as the decay of radioactive material, the Johnson-Nyquist noise of a resistor, the fluctuating intensity from a chaotic laser, etc. However, such TRNGs are either difficult to be integrated on chips or have very low generation rate. Therefore, a compact, integrable, and fast TRNG is highly desired.

Magnetic tunnel junction (MTJ) has been used for non-volatile information storage as magnetoresistic random access memory (MRAM). MRAM requires non-volatility and thermal stability. Therefore, free layer in the MTJ should have a sufficiently large volume and/or a sufficiently high energy barrier between equilibrium states, to ensure proper operation of an MRAM and long-term information storage.

### SUMMARY

In accordance with the disclosure, there is provided an apparatus including a magnetic tunnel junction (MTJ), a magnetic field generator, and a detection circuit. The MTJ includes a free layer configured to switch between a first equilibrium state and a second equilibrium state, a reference layer, and an insulator layer sandwiched between the free layer and the reference layer. The magnetic field generator is configured to apply a magnetic field to the free layer to reduce a barrier between the first equilibrium state and the second equilibrium state. The detection circuit is configured to detect a resistance state of the MTJ, and generate a bit value for a random number based on the resistance state of the MTJ.

In accordance with the disclosure, there is provided a method including applying a magnetic field to a free layer of a magnetic tunnel junction (MTJ) to reduce a barrier between a first equilibrium state and a second equilibrium state, detecting a resistance state of the MTJ, and generating a bit value for a random number based on the resistance state of the MTJ. The free layer of the MTJ is configured to switch between the first equilibrium state and the second equilibrium state. The MTJ also includes a reference layer and an insulator layer sandwiched between the free layer and the reference layer,

### BRIEF DESCRIPTION OF THE DRAWINGS

FIG. 1 is a schematic diagram of a true random number generator (TRNG) consistent with embodiments of the present disclosure.

FIG. 2 shows stable orientations of magnetization of a free layer of a magnetic tunnel junction (MTJ) of the TRNG in various circumstances.

FIG. 3 shows free energy in the free layer as a function of magnetization polar angle.

FIG. 4 shows barrier height and stable position as functions of strength h of a transverse external magnetic field applied to the free layer.

FIG. 5A shows time series of z component of magnetization of the free layer for h=0.

FIG. 5B shows time series of z component of magnetization of the free layer for h=0.4.

FIG. 5C shows time series of z component of magnetization of the free layer for h=0.8.

FIG. 6 shows fluctuation switching time as a function of a height of a barrier between two equilibrium states of the free layer.

FIG. 7 shows a passing sampling frequency as a function of the strength of the transverse external magnetic field applied to the free layer.

FIG. 8 shows the passing sampling frequency as a function of the strength of the external magnetic field in a scenario where the external magnetic field slightly deviates from the transverse direction (α=89.8°).

FIG. 9 shows an enhanced passing sampling frequency at the strength of the transverse magnetic field of h=0.9 in the scenario where α=89.8° with different numbers of XOR operations in comparison with RAW sampling.

FIG. 10A schematically shows the impact of the z component of the external magnetic field on the symmetry of the equilibrium states of the free layer.

FIG. 10B schematically shows the impact of a current passing through the MTJ on the symmetry of the equilibrium states of the free layer.

FIG. 11 shows a probability distribution of a p-bit based on MTJ-based TRNG as functions of a strength of a longitudinal magnetic field and a density of an injected current.

FIG. 12 schematically shows a p-circuit with three p-bits consistent with the disclosure.

FIG. 13 shows statistical results of the p-circuit according to an embodiment of the disclosure.

FIG. 14 is a schematic flowchart of a method for generating true random number consistent with embodiments of the present disclosure.

### DETAILED DESCRIPTION OF THE EMBODIMENTS

Hereinafter, embodiments of the disclosure will be described with reference to the drawings, which are merely examples for illustrative purposes and are not intended to limit the scope of the disclosure. Wherever possible, the same reference numbers will be used throughout the drawings to refer to the same or similar parts.

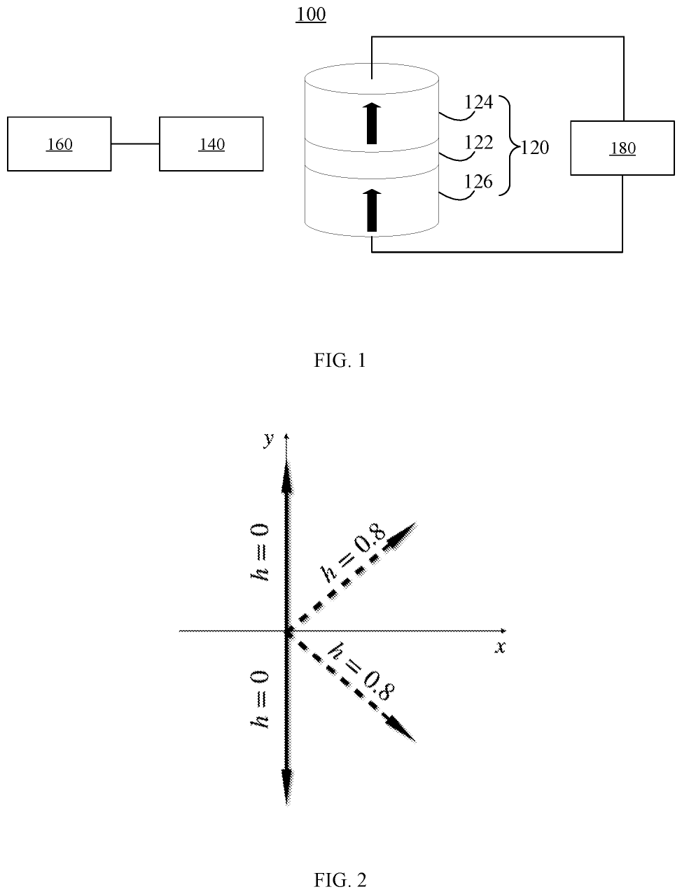

FIG. 1 is a schematic diagram of a true random number generator (TRNG) 100 (i.e., an apparatus for generating true random numbers) consistent with embodiments of the present disclosure. As shown in FIG. 1, the TRNG 100 includes a magnetic tunnel junction (MTJ) 120 and a magnetic field generator 140. The MTJ 120 includes two magnetic layers sandwiching a thin insulator layer 122. The two magnetic layers include a free layer 124 arranged at one side of the insulator layer 122, and a reference layer 126 arranged at another side of the insulator layer 122. In the example shown in FIG. 1, the free layer 124 and the reference layer 126 are arranged above and below the insulator layer 122, respectively. In some embodiments, the MTJ 120 may also include one or more other layers.

The insulator layer 122 is made of an insulating material, such as aluminum oxide or magnesium oxide, and can be sufficiently thin to allow electrons to tunnel through it from the reference layer 126 to the free layer 124 or vice versa. The resistance for the electrons to tunnel through the insulator layer 122 is called tunneling magnetoresistance (TMR), which can be impacted by the relative magnetization orientations in the free layer 124 and the reference layer 126.

In some embodiments, the free layer 124 and the reference layer 126 are each made of a magnetic material, such as a ferromagnetic material, for example, iron, cobalt, cobalt-iron alloy, cobalt-iron-boron alloy, etc. The materials for the free layer 124 and the reference layer 126 can be the same or different.

The orientation of magnetization (magnetization orientation) of the reference layer 126 can be fixed and the magnetization orientation of the free layer 124 can be changed (e.g., flipped) among different directions, such as switching between two directions, i.e., a first magnetization direction of the free layer 124 and a second magnetization direction of the free layer 124. The two directions (the first and second magnetization directions of the free layer 124) can have a non-zero angle formed therebetween. For example, the two directions can be opposite to each other. Changing/switching of the magnetization orientation in the free layer 124 can result in change of the resistance of the MTJ 120, which can be detected and used to indicate different states of the MTJ 120. The different states of the MTJ 120 can be used to represent different information or data, such as bit-0 and bit-1. The switching of the magnetization orientation in the free layer 124 between two directions can be caused by applying an external magnetic field, and can also occur spontaneously. This spontaneous switching of the magnetization orientation in the free layer 124 can be stochastic, causing random bit fluctuation, which can be used for generating true random numbers.

The magnetization orientation in the free layer 124 and that in the reference layer 126 can be parallel to the interfaces between different layers of the MTJ 120, have a certain non-zero angle with respect to the interfaces, or be perpendicular to the interfaces (referred to as “perpendicular magnetic anisotropy (PMA)”). In this disclosure, as shown in FIG. 1, an MTJ with PMA is used as example for description. In some other embodiments, the MTJ may have a different anisotropy. In the example shown in FIG. 1, the reference layer 126 has a magnetization in a direction perpendicular to an upper surface of the reference layer 126, such as pointing upward. Similarly, the free layer 124 also has a magnetization pointing in a direction perpendicular to an upper surface of the free layer 124 in the absence of an external magnetic field, such as pointing upward or downward, and the magnetization orientation of the free layer 124 can switch between two directions, such as between the upward direction and the downward direction.

In some embodiments, the free layer 124 and the reference layer 126 may have an approximately same width and/or an approximately same structure. In some embodiments, the free layer 124 and the reference layer 126 may have different widths and/or different structures.

The magnetic field generator 140 can be configured to generate a magnetic field to be applied to the MTJ 120. An angle between the direction of the magnetic field applied to the MTJ 120 and anisotropy of the free layer 124 (the magnetization direction of the free layer 124 in the absence of the magnetic field) can be in a range of 0°-90°, such as 90°. For example, the magnetization of the free layer 124 can be in a direction perpendicular to an interface between the free layer 124 and the insulator layer 122 of the MTJ 120 when no external magnetic field is applied, and the magnetic field applied by the magnetic field generator 140 to the free layer 124 can be parallel to the interface (perpendicular to the magnetization direction of the free layer 124 without external magnetic field). To simplify description and analysis, a dimensionless magnetic field strength h is used in this disclosure to represent the strength of the magnetic field applied by the magnetic field generator 140 to the MTJ 120 (e.g., to the free layer 124). Definition or calculation of the dimensionless magnetic field strength h can vary depending on the structure of the MTJ 120, such as the anisotropy of the MTJ 120. In some embodiments, the dimensionless magnetic field strength h can be calculated as a ratio between the actual strength H of the magnetic field applied to the MTJ 120 (e.g., to the free layer 124) and the strength K of the anisotropy in the free layer 124, i.e., h≡H/K, as described in more detail later. In some embodiments, the magnetic field generator 140 can be controlled to apply a magnetic field to the MTJ 120 (e.g., to the free layer 124) with a dimensionless strength smaller than 1, such as a value in a range of 0.4 to 0.9, or in a range of 0.6 to 0.8. For example, the dimensionless strength of the applied magnetic field can be about 0.8. In some other embodiments, a different parameter can be used to characterize the strength of the external magnetic field. Further, a different parameter can be used to represent or characterize the strength of the magnetic field applied by the magnetic field generator 140 to the MTJ 120 (e.g., to the free layer 124).

In some embodiments, the magnetic field generator 140 may include a permanent magnet or an electromagnet. The permanent magnet may include a material or object that produces a magnetic field. The electromagnet is a type of magnet in which the magnetic field is produced by an electric current. The electromagnet may include a wire wound into a coil. The magnetic field produced by the electromagnet can change based on the electric current.

In some embodiments, as shown in FIG. 1, the TRNG 100 further includes a control circuit 160 configured to control the operation of the magnetic field generator 140. The control circuit 160 can be configured differently and have different functions depending on the configuration of the magnetic field generator 140, as described in more detail below.

In some embodiments, the magnetic field generator 140 includes a permanent magnet and also a mechanism (also referred to as an “actuation mechanism”) configured to move the permanent magnet, such as moving the permanent magnet closer to or away from the MTJ 120, in particular, closer to or away from the free layer 124, or adjusting an angle of the permanent magnet with respect to the MTJ 120, in particular, with respect to the free layer 124. As such, the external magnetic field can be applied to the free layer 124 to change the magnetization orientation in the free layer 124, and the intensity and direction of the external magnetic field can be adjusted.

In some embodiments, the actuation mechanism can include one or more motors and one or more transmission assemblies coupling the one or more motors to the permanent magnet. The one or more motors can include one or more rotatory motors and/or one or more linear motors, and the one or more transmission assemblies can translate the rotational and/or linear movement of the one or more motors into the rotational and/or linear movement of the permanent magnet, to adjust the distance and angle between the permanent magnet and the free layer 124, so as to adjust the intensity and direction of the external magnetic field applied to the free layer 124.

In the embodiments described above, the control circuit 160 can be configured to control the operation of the actuation mechanism that moves the permanent magnet. For example, the control circuit 160 can control the intensity and timing of the current applied to each of the one or more motors to control when the motor operates and how fast the motor operates.

In some embodiments, the magnetic field generator 140 includes a permanent magnet and also a shield mechanism. The shield mechanism can shield the magnetic field of the permanent magnet or allow the magnetic field of the permanent magnet to be applied to the free layer 124.

In these embodiments, the control circuit 160 can control the shield mechanism to at least partially shield the free layer 124 from exposing to the magnetic field of the permanent magnet or to allow the magnetic field of the permanent magnet to be applied to the free layer 124.

In some embodiments, the magnetic field generator 140 includes a permanent magnet and both an actuation mechanism for moving the permanent magnet and a shield mechanism for at least partially shielding the permanent magnet. In these embodiments, the control circuit 160 can control the actuation mechanism and/or the shield mechanism to change the direction and/or intensity of the external magnetic field applied to the free layer 124.

In some embodiments, the magnetic field generator 140 can include an electromagnet instead of or in addition to the permanent magnet. The control circuit 160 can be configured to control intensity of the electric current applied to the electromagnet to control the magnetic field generated by the electromagnet, which is applied to the free layer 124 as the external magnetic field. In the embodiments with the electromagnet in the magnetic field generator 140, the magnetic field generator 140 can also include an actuation mechanism and/or a shield mechanism similar to those described above.

In some embodiments, the electromagnet can include a layer of electromagnetic material arranged near the free layer 124, such as over or below the free layer 124.

In some embodiments, as shown in FIG. 1, the TRNG 100 further includes a detection circuit 180 configured to detect the resistance state (and hence the relative magnetization orientations of the free layer 124 and the reference layer 126) of the MTJ 120 and to generate a random number based on the resistance state of the MTJ 100. In some embodiments, the detection circuit 180 is configured to generate bit-0 when the MTJ 120 is in the low resistance state (i.e., the magnetization orientations of the free layer 124 and the reference layer 126 have an angle between each other of smaller than 90° and larger than or equal to 0°, e.g., are parallel relative to each other (angle being 0°)), and generate bit-1 when the MTJ 120 is in the high resistance state (i.e., the magnetization orientations of the free layer 124 and the reference layer 126 have an angle between each other of larger than 90° and smaller than or equal to 180°, e.g., are anti-parallel relative to each other (angle being 180°), or vice versa. The resistance of the MTJ 120 in the high resistance state is higher than the resistance of the MTJ 120 in the low resistance state. Due to thermal instability, the MTJ 120 can randomly switch between the low resistance state and the high resistance state, and hence by detecting the resistance state of the MTJ 120, the detection circuit 180 can randomly generate bit-0 and bit-1, producing random numbers. The difficulty for the MTJ 120 to switch between the two resistance states, and hence the generation rate of the random numbers, can be affected by various factors, such as the potential barrier separating the two equilibrium states of the free layer 124, as will described in more detail below. Further, the barrier height of the potential barrier can be affected by the external magnetic field applied to the free layer 124, as will be described in more detail below.

In some embodiments, each of the control circuit 160 and the detection circuit 180 can include one or more processors configured to control various components of the apparatus and/or generate various signals/outputs. In some embodiments, the control circuit 160 and the detection circuit 180 can be integrated as one circuit, which can include one or more processors configured to control various components of the apparatus and/or generate various signals/outputs.

The operation of the TRNG 100 is described in more detail below with the MTJ 120 being an MTJ with PMA as an example. In the description below, the magnetization of the reference layer 126 is assumed to be pinned in the perpendicular direction, i.e., along 2 axis, and the magnetization of the free layer 124 can be influenced by the external magnetic field applied by the magnetic field generator 140. In some embodiments, the impact of the applied magnetic field on the tunneling magnetoresistance between the free layer 124 and the reference layer 126 of the MTJ 120 is less than one order of magnitude, therefore a read-out signal of the MTJ 120 is not compromised.

Let the direction of the magnetic moment in the free layer 124 be denoted by unit vector [symbol] , and the PMA is along the \hat{z} axis with strength K. Total free energy of the magnetization of the free layer 124 can be calculated by Eq. (1):

F( [symbol] )=—μ₀MₛV[ [symbol] · [symbol] +½K( [symbol] ·\hat{z})²] (1)

where μ₀=1.26×10⁻⁶ TmA⁻¹ is the vacuum permeability, and Mₛ and V are the saturation magnetization and the volume of the free layer 124, respectively. In a spherical coordinate, [symbol] =(sin θ cos ϕ, sin θ sin ϕ, cos θ), where θ and ϕ denote a polar angle and an azimuthal angle, respectively, with respect to \hat{z}. [symbol] denotes the strength of the external magnetic field, and can be expressed as [symbol] =H(sin α, 0, cos α), where a denotes a tilts angle from \hat{z}.

By minimizing F( [symbol] ) with respect to θ and ϕ, the equilibrium direction [symbol] ₀ is given by Eq. (2):

ϕ₀=0 and 2h sin(α−θ₀)−sin 2θ₀=0 (2)

where h≡H/K is the dimensionless magnetic field strength. The inequality 2 h cos(α−θ₀)+cos 2θ₀>0 must also be satisfied to guarantee stability. For example, when the external magnetic field points in the transverse direction, i.e., α=90°, and if the strength of the external magnetic field is not so strong (h<1), there are two stable solutions pointing to the northern and southern hemisphere, respectively. These two stable solutions representing two equilibrium states, a first equilibrium state and a second equilibrium state, of the MTJ 120 (i.e., two equilibrium states of the free layer 124). The first magnetization direction of the free layer 124 mentioned above is a magnetization direction of the free layer 124 when the free layer 124 is in the first equilibrium state, and the second magnetization direction of the free layer 124 mentioned above is a magnetization direction of the free layer 124 when the free layer 124 is in the second equilibrium state. On the other hand, if the magnetic field is strong (h>1), there is only one stable solution.

The magnetization dynamics upon the equilibrium [symbol] ₀ is governed by the Landau-Lifshitz-Gilbert (LLG) equation (Eq. (3)).

$$\frac{\partial \vec{m}}{\partial t} = - γ \vec{m} \times [ {\vec{H}}_{eff} + \vec{h} ( t ) ] + β \vec{m} \times \frac{\partial \vec{m}}{\partial t} \qquad ( 3 )$$

where γ is the gyromagnetic ratio, β is the phenomenological Gilbert damping constant, and [symbol] _{eff} is the effective magnetic field, which can be defined by Eq. (4).

$${\vec{H}}_{eff} [ \vec{m} ] = - \frac{1}{{M}_{s} V} \frac{\partial F ( \vec{m} )}{\partial \vec{m}} = \vec{H} + {Km}_{z} \hat{z} \qquad ( 4 )$$

The thermal fluctuation is modeled via a random magnetic field [symbol] (t), which is proportional to temperature according to the fluctuation-dissipation theorem, as shown in Eq. (5).

$$〈 {h}_{i} ( t ) {h}_{j} ( {t}^{′} ) 〉 = \frac{2 {k}_{B} T}{{M}_{s} V} δ ( t - {t}^{′} ) \qquad ( 5 )$$

The thermal fluctuation in the magnetic state in the MTJ 120 can be used for generating true random numbers. A rate of random number generation is determined by the ratio Δ/k_{B}T, where Δ represents the energy barrier separating the first equilibrium state and the second equilibrium state, and k_{B}T represents the thermal activation energy. The energy barrier Δ, also referred to as “state switching barrier,” is a barrier for the MTJ 120 to switch between the two equilibrium states, which is different from the barrier for the electrons to tunnel through the insulator layer 122. In other words, the energy barrier Δ is one factor that determines how much energy (e.g., thermal energy) is needed for the MTJ 120 (the free layer 124) to switch from one of the two equilibrium states to another, or vice versa. The energy barrier Δ can be reduced by the transverse magnetic field applied to the MTJ 120 (i.e., applied to the free layer 124).

FIG. 2 shows the stable orientation of the magnetization [symbol] ₀ of the free layer 124 in various circumstances. In FIG. 2, solid arrows represent the stable orientations of the magnetization [symbol] ₀ in the absence of the external magnetic field and the dashed arrows represent the stable orientations of the magnetization [symbol] ₀ in the presence of a transverse magnetic field (h=0.8) (represented by the dash-dotted arrow) applied along \hat{x} direction. As shown in FIG. 2, in the absence the transverse magnetic field (h=0), the two stable states point to the north pole (\hat{z}) and south pole (−\hat{z}), separated by a potential barrier Δ₀∝K. A transverse magnetic field (h≠0) applied in \hat{x} direction tends to bring the two stable states closer to the equator toward \hat{x}, leading to a reduced barrier height and barrier width.

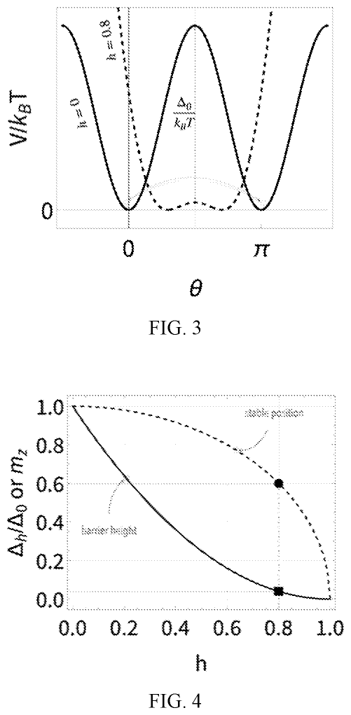

FIG. 3 shows free energy as a function of the magnetization polar angle θ. In FIG. 3, the solid curve illustrates the scenario in which no external magnetic field is applied, i.e., h=0, and the dashed curve illustrates the scenario in which a transverse (α=7π/2) magnetic field of h=0.8 is present. As shown in FIG. 3, the two minima on each curve indicate the stable orientations of the free layer magnetization. Δ denotes the height of the barrier separating the two minima.

FIG. 4 shows the barrier height (Δₕ, solid curve) and the stable position (|m_{z}|=|cos θ₀|, z component of [symbol] ₀, dashed curve) as a function of the strength h of the transverse (α=π/2) magnetic field. As shown in FIG. 4 (and also in FIG. 3), increasing the strength of the transverse magnetic field noticeably reduces the barrier height and also brings the two stable positions closer. The barrier height Δₕ can be tuned by the transverse magnetic field h very efficiently. However, the impact of the transverse magnetic field on the stable positions is modest as long as the strength of the transverse magnetic field is not too close to 1. For example, as shown in FIG. 4, at h=0.8 (indicated by the vertical dashed line), the stable orientation of magnetization still has a value of m_{z}≈0.6 (indicated by the solid circle point), although the barrier height is close to zero (indicated by the solid square point). Since the tunneling magnetoresistance of the MTJ 120 is approximately proportional to m_{z}, this means that the tunneling magnetoresistance of the MTJ 120 at h=0.8 is about 60% of the full magnetoresistance of the MTJ 120 at h=0.

As noted above, stochastic switching between the two equilibrium states (i.e., switching of the free layer magnetization orientation between the two stable positions) of the MTJ 120 due to thermal fluctuation can be used to generate random numbers, which is discussed in more detail below. In some embodiments, the free layer 124 includes a CoFeB layer with perpendicular magnetic anisotropy (PMA), and has a saturation magnetization Mₛ=9.57×10⁵ A m⁻¹, a perpendicular crystalline anisotropy constant K=3.86×10⁵ A m⁻¹, an exchange coupling constant A=1.3×10⁻¹¹ Jm⁻¹, a gyromagnetic ratio γ=2.01×10⁵ Hz A m⁻¹, and a damping factor β=0.01. The operating temperature is room temperature T=300K. The volume of the free layer 124 is V_{ƒ}=5 nm×10 nm×10 nm=500 nm³, which has a potential barrier Δ₀=Δ₀MₛV_{ƒ}K/2≈28 k_{B}T.

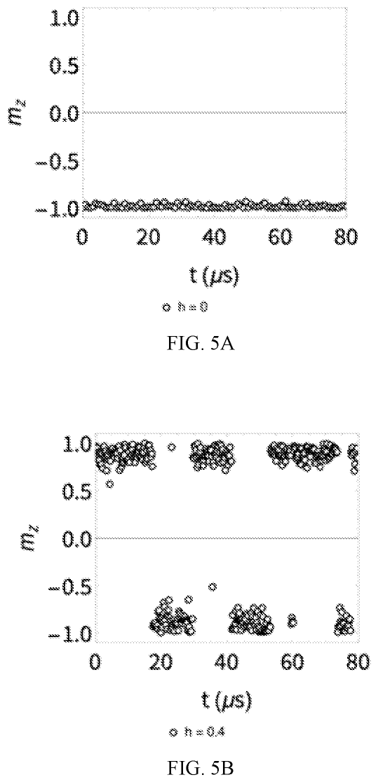

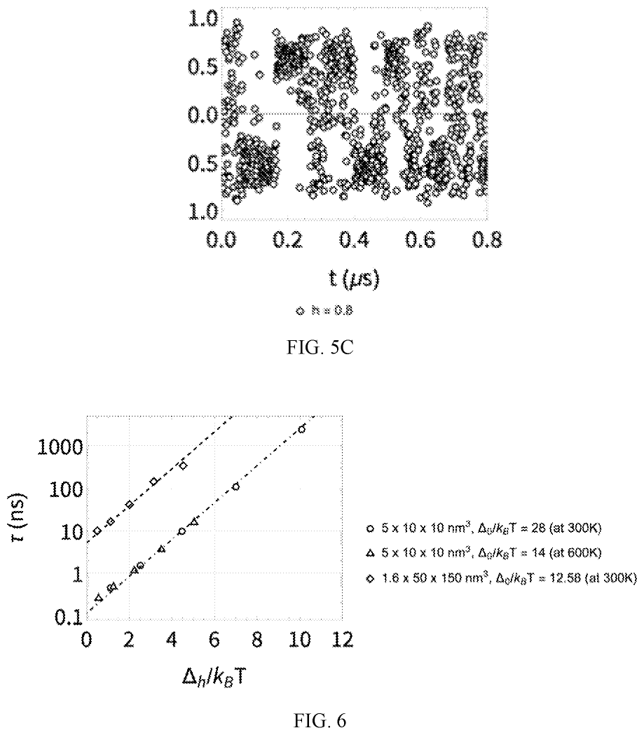

The random switching between the first equilibrium state on the northern hemisphere and the second equilibrium state on the southern hemisphere can be reflected by solving the stochastic LLG equation (Eq. (3)). FIGS. 5A-5C show the time series of m_{z}(t) for h=0, 0.4, 0.8, respectively. In FIGS. 5A-5C, the m_{z}(t) value is recorded every 0.1 ns, or at a recording frequency of ƒ_{record}=10 GHz. As shown in FIGS. 5A-5C, the time series of m_{z}(t) exhibit the telegraph noise character. A list of binary random numbers are obtained via TMR, or equivalently sign [m_{z}(t)]=0 or 1.

FIG. 6 shows fluctuation switching time τ (mean waiting time before m_{z} switches from one hemisphere to the other) as a function of the h-modulated barrier height Δh. FIG. 6 shows three data sets for three scenarios with different free layer volumes and/or different temperatures (and hence different Δ₀/k_{B}T values, as noted in the figure), where the data points in the figure for each set correspond to h=0.8, 0.7, 0.6, 0.5, 0.4, respectively, from left to right in the figure.

As shown in FIG. 4 and described above, the barrier height and the barrier width are both modulated by h, and both decrease as the transverse magnetic field h increases from 0 to 1. Correspondingly, as shown in FIG. 6, the fluctuation switching time τₕ decreases approximately exponentially as the barrier height Δₕ decreases (which is caused by the increase of the transverse magnetic field h). The change of the fluctuation switching time τₕ as a function of the barrier height Δₕ can be fitted (the straight lines in the figure) using Eq. (6) below:

τₕ=τ₀exp[(Δh−Δ₀)/k_{B}T] (6)

where τ₀ is a natural fluctuation switching time at h=0, i.e., in the absence of the external magnetic field.

The NIST Statistical Test Suite is used to check the quality of the random number stream generated according to the present disclosure. Eight tests are applied to the stream: i) Monobit, ii) Frequency within block, iii) Runs, iv) Long run ones in a block, v) Serial, vi) Discrete Fourier transform, vii) Non-overlapping template matching, viii) Serial random excitation variant.

The recorded stream data is sampled every n numbers, i.e., the sampling frequency is ƒ=ƒ_{record}/n. The sampled list is checked to determine whether it passes the above tests. For the i-th test, a highest passing sampling frequency ƒᵢ below which the sampled numbers can pass the i-th test is determined. A minimum one of all passing frequencies ƒₚₐₛₛ=min (ƒ₁, . . . ƒ₈) determines the random number generation rate that can pass all eight tests. The random number generation rate can be roughly estimated by an inverse of the fluctuation switching time: ƒₚₐₛₛ≈τ⁻¹.

When the magnetic field is applied in the transverse \hat{x} direction (α=90°), the first equilibrium state and the second equilibrium state are located symmetrically about the equator, corresponding to an equal probability of 0s and 1s.

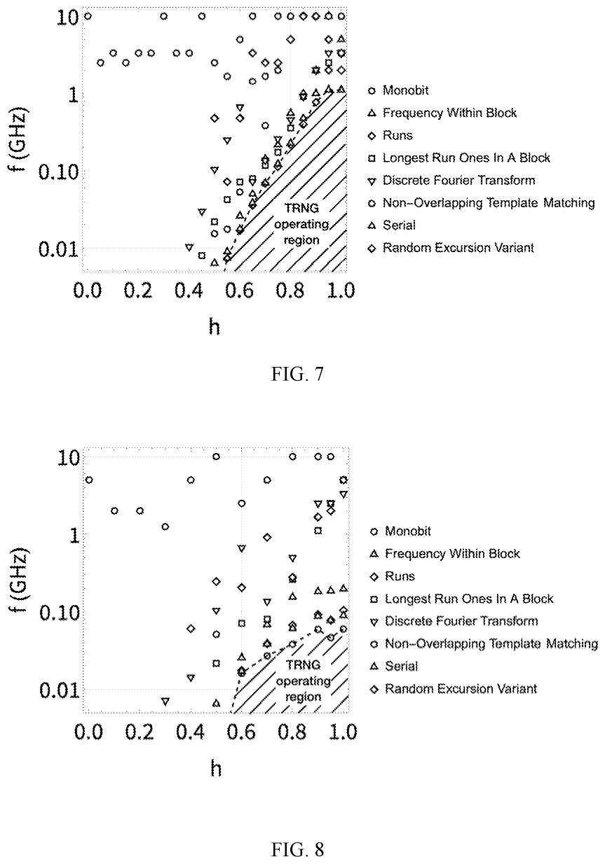

FIG. 7 shows the passing sampling frequency ƒᵢ as a function of the strength of the transverse magnetic field up to h=1, beyond which the system is no longer bistable. As shown in FIG. 7, as the field strength approaches h=1, the minimum passing frequency ƒₚₐₛₛ(h) increases by several orders of magnitude up to 1 GHz. This frequency agrees with the estimation using the fluctuation switching time shown in FIG. 6 (square data points), which shows that the fluctuation switching time at h=0.8 is around 1 ns, and correspondingly the inverse of the fluctuation switching time at h=0.8 is τ_{h=0.8}⁻¹≈1 GHz. By extrapolating the solid line in FIG. 6 via Eq. (6), the estimated natural switching time at h=0 (correspondingly, Δ₀/k_{B}T=28) is τₕ≈100 s and thus ƒₚₐₛₛ(h=0)≈0.01 Hz. Therefore, in this scenario, the application of the transverse magnetic field h can enhance the generation rate of the MTJ-based TRNG by 10 to 11 orders of magnitude from about 0.01 Hz to about 1 GHz.

As another example, the free layer 124 has a volume of V_{ƒ}=1.6 nm×50 nm×150 nm=1.2×10⁴ nm³, and an in-plane uniaxial magnetic anisotropy of K≈7.2×10³ Am⁻¹. These values correspond to an intrinsic barrier height of Δ₀≈12.58 k_{B}T. The MTJ-based TRNG having such free layer has a natural fluctuation switching time of τ_{h=0≈1} ms, according to extrapolation of the dashed line in FIG. 6 via Eq. (6), which corresponds to a random number generation passing frequency ƒₚₐₛₛ(h=0) of about 1 KHz. In these embodiments, application of the transverse magnetic field of h=0.8 lowers the barrier height and reduces the switching time to τ_{h=0.8}≈10 ns (see FIG. 6), corresponding to a random number generation passing frequency ƒₚₐₛₛ(h=0.8)≈0.1 GHz. That is, applying a transverse magnetic field of h=0.8 to the free layer 124 with a volume of 1.6 nm×50 nm×150 nm can increase the random number generation rate by 5 orders of magnitude from 1 KHz to 0.1 GHz.

From the two examples shown in FIG. 6 and described above, it can be seen that a transverse magnetic field can significantly increase the random number generation rate of an MTJ-based TRNG. Although a high random number generation rate from a TRNG had been a long term desire, increasing the generation rate by applying an external magnetic field to an MTJ-based TRNG, such as increasing the generation rate by applying an external magnetic field in a direction perpendicular to the magnetization direction in the free layer of the MTJ-based TRNG, was never proposed by others before.

As the transverse magnetic field reduces the barrier height, it also brings the two equilibrium orientations closer to the equator, i.e., m_{z}, the z component of [symbol] ₀, becomes smaller. Since the random bit is read out through tunneling magnetoresistance (TMR) and TMR is approximately proportional to m_{z}, as the generation rate is enhanced by the transverse magnetic field, read-out of the random bit via TMR may become more difficult. Therefore, the strength h of the external magnetic field applied to the free layer 124 needs to be properly selected and controlled. On the one hand, h needs to be large enough to introduce a significant increase in the random number generation rate; while on the other hand, h should not be too large (for example, not close to 1) to maintain a TMR that is large enough for random bit read out.

For example, as shown in FIG. 4, as h increases from 0 to 0.8, m_{z} merely reduces from |m_{z}|=1 to 0.6, which means that the reduction of the tunneling magnetoresistance is less than a factor of two. However, the random number generation rate is enhanced by several orders of magnitude as h increases from 0 to 0.8.

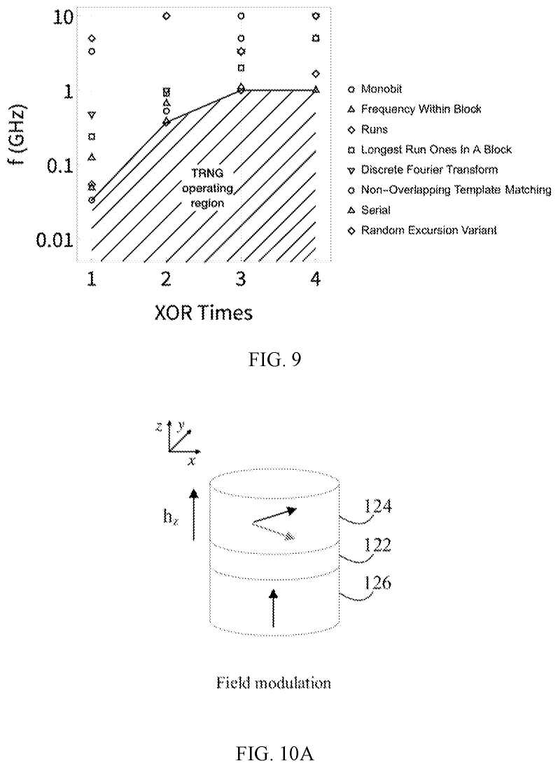

In case that the applied transverse field is not perfectly aligned with \hat{x}, the first equilibrium state and the second equilibrium state may be asymmetrical about the equator, leading to an imbalance probability of output 0s and 1s. For example, in the case with α=89.8°, the passing frequency decreases by a factor of ten as shown in FIG. 8. To obtain more balanced random numbers, a possible solution is to use eXclusive OR (XOR) operation (a Boolean logic operation) between the unbalanced random numbers. FIG. 9 shows an enhanced passing sampling frequency ƒᵢ for the strength of the transverse magnetic field h=0.9 (α=89.8°) with different numbers of XOR operation in comparison with the RAW sampling (XOR2ⁿ means XOR n times, for example, XOR2 means XOR once, XOR4 means XOR twice, and so on so forth). As shown in FIG. 9, with XOR, the passing frequency is greatly enhanced. In some embodiments, applying XOR operation once (XOR2) would be sufficient to restore the 1 GHz passing frequency.

A good random number generator requires a balanced probability of output 0 and 1, 50% for each case. With slight modification, a random number generator can also be modified as a probabilistic bit (p-bit), which has random outputs of 0 with probability p and 1 with probability 1-p, where p∈[0,1] can be controlled via input. The p-bits can be used to construct a probabilistic computer to solve certain optimization problems that are difficult to solve in conventional computers, for example, an invertible Boolean logic problem, a travel-salesman problem, an integer factorization, or quantum simulation problems such as a quantum transverse Ising problem.

In some embodiments, a stochastically fluctuating MTJ can be used as a probabilistic bit (p-bit), which takes on values 0 and 1 with tunable probabilities. The p-bits are the building block for a probabilistic-computer (p-computer). The p-computer works better when an updating speed of p-bits is faster, but slower than a speed of the synapses interconnecting different p-bits. Therefore, the p-bits need to have tunable activation time to match the synapse time. An MTJ-based TRNG can achieve reduced or tunable activation time via the transverse magnetic field as disclosed above. In some embodiments, the transverse field h may tune the MTJ-based TRNG continuously from a p-bit all the way to a deterministic bit (d-bit), with a thermal activation time varying in many orders of magnitude as shown in FIG. 6.

In addition to the fluctuating nature, a p-bit also needs to have a tunable probability distribution, which is controlled via some input containing the state information from other p-bits and external bias. In some embodiments, a p-bit can be implemented by combining an MTJ-based TRNG with several transistors and using electric voltage as an input to tune the probability distribution of the p-bit. In some embodiments, the probability distribution of a p-bit constituted by an MTJ-based TRNG can be tuned via a magnetic field or an electric current.

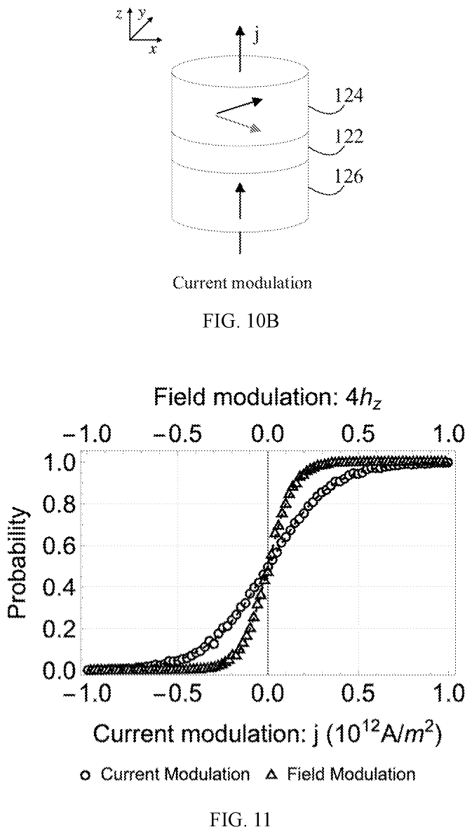

As described above, a transverse magnetic field tilts the two equilibrium states in a free layer (such as the free layer 124) of an MTJ from north and south poles towards the equator, resulting in a reduced barrier and henceforth a higher fluctuating rate of the TRNG. Also as described above, a magnetic field deviating from the x direction, i.e., a magnetic field having a longitudinal component (z component) along the anisotropy axis, can break the symmetry between the two energy minima, leading to the biased probability between the tilted equilibrium states. FIG. 10A schematically shows the impact of the z component (denoted as h_{z}) of the external magnetic field on the symmetry of the equilibrium states of the free layer (denoted by the two arrows in the free layer 124 in the figure). The x component hₓ of the external magnetic field is not shown in the figure. As shown in FIG. 10A, application of an external magnetic field with a non-zero z component causes the two equilibrium states to be not symmetric about the x-axis.

Similar symmetry breaking can also be realized via current-induced spin-transfer torque. FIG. 10B schematically shows the impact of a current (denoted as j in the figure) passing through the MTJ on the symmetry of the equilibrium states of the free layer.

FIG. 11 shows a probability distribution of a p-bit based on MTJ-based TRNG with a longitudinal magnetic field h_{z} (data points represented by square dots) and an electric current j (data points represented by circular dots) as tuning parameters. For each of the two sets of data points, a Sigmoid function S(x)=[1+exp (−x/w)]⁻¹ fitting is overlayed thereon. Both in the case that the longitudinal magnetic field h_{z} as the tuning parameter and the case that the electric current j as the tuning parameter, the probability distribution follows the Sigmoid function as a function of the controlling parameter.

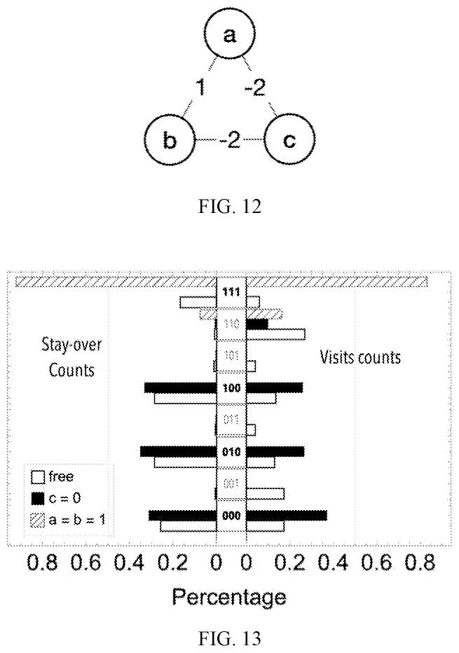

FIG. 12 schematically shows a p-circuit with three p-bits consistent with the disclosure. Each of the three p-bits can include an MTJ-based TRNG consistent with the disclosure. The p-circuit in FIG. 12 implements an invertible AND gate satisfying an AND relation: a AND b=c. In some embodiments, the longitudinal magnetic field h_{z} or current j is used in the p-circuit to communicate information among the p-bits. The p-circuit implementing an AND gate based on three p-bits (a, b, c) has a cost function shown in Eq. (7).

E(a,b,c)=3c+ab−2ac−2bc (7)

where the cost function minimizes when {a, b, c} satisfy a truth table for AND, i.e., a AND b=c. An output from two p-bits into the longitudinal magnetic field h_{z} can be mapped onto the third p-bit according to the following expressions:

$${h}_{z}^{a} = - \frac{\partial E}{\partial a} = - b + 2 c , {h}_{z}^{b} = - \frac{\partial E}{\partial b} = - a + 2 c , \\ {h}_{z}^{c} = - \frac{\partial E}{\partial c} = 2 a + 2 b - 3 \qquad ( 8 )$$

FIG. 13 shows statistical results of the p-circuit for the following three cases:
i) no constraint on (a, b, c) (“free” in the figure), implying that the p-circuit should yield one of the following instances satisfying the AND relation:
   {(0, 0, 0), (0, 1, 0), (1, 0, 0), (1, 1, 1)};
ii) pinning a=b=1 by setting a large positive bias longitudinal field or injecting a large current for p-bits a and b, implying that the p-circuit should yield a forward AND result as (a, b, c)=(1, 1, 1); and
iii) pinning c=0 by setting a large negative bias current for p-bit c, implying that the inverse AND result in one of the three cases: (a, b, c)={(0, 0, 0), (0, 1, 0), (1, 0, 0)}.

The statistical results are recorded using two different method: i) the visits counts, which record all visits to a certain state; and ii) the stay-over counts, which record only the repeated visits to a certain state of length two or more, but omitting those pass-by visits. As shown in FIG. 13, the stay-over counts give much less wrong answers than the simple visits counts. The p-circuit constructed using the MTJ-based TRNG p-bits consistent with the disclosure as being modulated by magnetic field can function properly to give correct results.

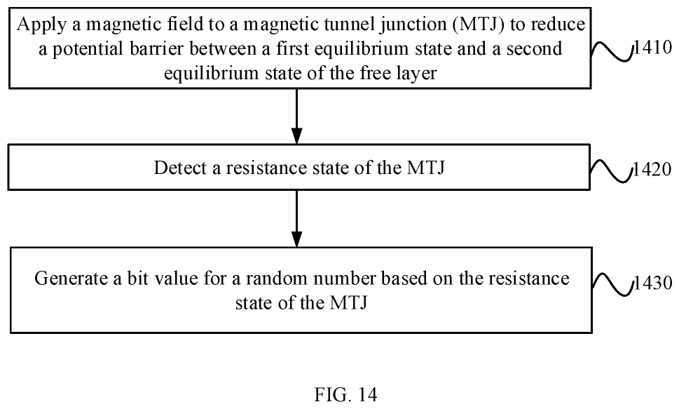

FIG. 14 is a schematic flowchart of a method 1400 for generating true random number consistent with embodiments of the present disclosure. The method 1400 can be implemented using, for example, the MTJ-based TRNG 100.

As shown in FIG. 14, at 1410, the magnetic field generator 140 is controlled to apply a magnetic field to the MTJ 120, e.g., to the free layer 124 of the MTJ 120. As described above, this applied magnetic field can reduce a potential barrier between a first equilibrium state and a second equilibrium state of the free layer 124.

In some embodiments, the magnetic field generator 140 includes a permanent magnet as described above, and the permanent magnet can be moved to a preset location so that the magnetic field of the permanent magnet can be applied to the MTJ 120. In some embodiments, the magnetic field generator 140 includes an electromagnet as described above, and an electric current can be applied to the electromagnet at the preset location so as to generate a magnetic field to apply to the MTJ 120. The preset location may include a location above or around the MTJ 120. The preset location may depend on, e.g., the construction and/or orientation of the magnetic field generator 140 and/or the anisotropy of the free layer 124 of the MTJ 120 (which can determine the desired orientation of the magnetic field applied to the free layer 124), for example, to apply a magnetic field to the free layer 124 that is not completely parallel to the magnetization direction in the free layer 124. For example, if the free layer 124 has a PMA (also called “out-of-plane anisotropy”), the magnet can be placed on the side of the free layer 124 to apply a magnetic field that has a non-zero angle with respect to the magnetization direction of the free layer 124, such as a magnetic field perpendicular to the magnetization direction of the free layer 124. As another example, if the free layer 124 has an in-plane anisotropy (i.e., magnetization direction of the free layer 124 is parallel to interfaces between layers of the MTJ 120), the magnet can be right above the free layer 124 of the MTJ 120.

In some embodiments, a direction of the magnetic field applied to the MTJ 120 forms an angle with respect to a magnetization direction of the free layer 124. In some embodiments, the angle between the direction of the applied magnetic field and anisotropy of the free layer 124 (the magnetization direction of the free layer 124 in the absence of the magnetic field) can be in a range of 0°-90°, such as 90°. For example, the magnetization of the free layer 124 can be in a direction perpendicular to an interface between the free layer 124 and the insulator layer 122 of the MTJ 120 when no external magnetic field is applied, and the magnetic field applied by the magnetic field generator 140 to the free layer 124 can be parallel to the interface (perpendicular to the magnetization direction of the free layer 124 without external magnetic field).

At 1420, a resistance state of the MTJ 120 is detected. The resistance state of the MTJ 120 can be detected via the detection circuit 180. In some embodiments, the resistance state of the MTJ 120 can be detected in response to the MTJ 120 switching between the first equilibrium state and the second equilibrium state. In some embodiments, the resistance state of the MTJ 120 can be detected periodically.

At 1430, a bit value is generated for a random number based on the resistance state of the MTJ 120. In some embodiments, the bit value can be generated by the detection circuit 180 based on the resistance state of the MTJ 120. In some embodiments, the detection circuit 180 is configured to generate bit-0 when the MTJ 120 is in a low resistance state, and generate bit-1 when the MTJ 120 is in a high resistance state, or vice versa. A series of bit values can be read out and processed to form a random number.

The MTJ-based TRNG is a promising TRNG apparatus for various scheme of stochastic computing. The speed and tunability of the MTJ-based TRNG is important for future widespread applications. A uniform transverse magnetic field can be sufficient to reduce the barrier height for all MTJ members in a memory array, and turn all deterministic memory bits into TRNG with GHz generation rate. In the meantime, the barrier can be restored to a high value by turning off the magnetic field, and the random numbers stored are frozen on demand.

The MTJ-based TRNG has an advantage of switching between a TRNG and a deterministic memory via a transverse magnetic field. That is, the TRNG can be frozen on demand. In some embodiments, the MTJ-based TRNG can be used as a p-bit via a longitudinal magnetic field or an injecting current, enabling a construction of p-circuits based purely on memories.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. An apparatus comprising:
a magnetic tunnel junction (MTJ) including:
a free layer configured to switch between a first equilibrium state and a second equilibrium state;
a reference layer; and
an insulator layer sandwiched between the free layer and the reference layer;
a magnetic field generator configured to apply a magnetic field to the free layer to reduce a barrier between the first equilibrium state and the second equilibrium state; and
a detection circuit configured to:
detect a resistance state of the MTJ; and
generate a bit value for a random number based on the resistance state of the MTJ.

2. The apparatus of claim 1, wherein an angle between a direction of the magnetic field and an anisotropy of the free layer is in a range of 0°-90°.

3. The apparatus of claim 2, wherein the angle is 90°.

4. The apparatus of claim 3, wherein a dimensionless strength of the magnetic field is larger than 0 and smaller than 1, the dimensionless strength of the magnetic field being a ratio between a strength of the magnetic field and a strength of the anisotropy of the free layer.

5. The apparatus of claim 4, wherein the dimensionless strength is larger than or equal to 0.4 and smaller than or equal to 0.9.

6. The apparatus of claim 5, wherein the dimensionless strength is larger than or equal to 0.6 and smaller than or equal to 0.8.

7. The apparatus of claim 6, wherein the dimensionless strength equals about 0.8.

8. The apparatus of claim 1, wherein a first magnetization direction of the free layer in the first equilibrium state is different from a second magnetization direction of the free layer in the second equilibrium state.

9. The apparatus of claim 8, wherein:
in absence of the magnetic field, the first magnetization direction is opposite to the second magnetization direction; and
in presence of the magnetic field, an angle between the first magnetization direction and the second magnetization direction is smaller than 180° and larger than 0°.

10. The apparatus of claim 8, wherein the detection circuit is configured to detect the MTJ to be in:
a low resistance state in response to a magnetization of the free layer being in the first magnetization direction, an angle between the first magnetization direction and a magnetization direction of the reference layer being smaller than 90° and larger than or equal to 0°, and
a high resistance state, in which a resistance of the MTJ is higher than in the low resistance state, in response to the magnetization of the free layer being in the second magnetization direction, an angle between the second magnetization direction and the magnetization direction of the reference layer being larger than 90° and smaller than or equal to 180°.

11. A method comprising:
applying a magnetic field to a free layer of a magnetic tunnel junction (MTJ) to reduce a barrier between a first equilibrium state and a second equilibrium state of the free layer, the free layer of the MTJ being configured to switch between the first equilibrium state and the second equilibrium state, and the MTJ further including a reference layer and an insulator layer sandwiched between the free layer and the reference layer;
detecting a resistance state of the MTJ; and
generating a bit value for a random number based on the resistance state of the MTJ.

12. The method of claim 11, wherein applying the magnetic field includes applying the magnetic field at a direction having an angle with an anisotropy of the free layer that is in a range of 0°-90°.

13. The method of claim 12, wherein applying the magnetic field includes applying the magnetic field perpendicular to the anisotropy of the free layer.

14. The method of claim 11, wherein applying the magnetic field includes applying the magnetic field with a dimensionless strength of larger than 0 and smaller than 1, the dimensionless strength of the magnetic field being a ratio between a strength of the magnetic field and a strength of the anisotropy of the free layer.

15. The method of claim 14, wherein applying the magnetic field includes applying the magnetic field with the dimensionless strength of larger than or equal to 0.4 and smaller than or equal to 0.9.

16. The method of claim 15, wherein applying the magnetic field includes applying the magnetic field with the dimensionless strength of larger than or equal to 0.6 and smaller than or equal to 0.8.

17. The method of claim 16, wherein applying the magnetic field includes applying the magnetic field with the dimensionless strength of about 0.8.

18. The method of claim 11, wherein a first magnetization direction of the free layer in the first equilibrium state is different from a second magnetization direction of the free layer in the second equilibrium state.

19. The method of claim 18, wherein:
in absence of the magnetic field, the first magnetization direction is opposite to the second magnetization direction; and
in presence of the magnetic field, an angle between the first magnetization direction and the second magnetization direction is smaller than 180° and larger than 0°.

20. The method of claim 18, wherein detecting the resistance state of the MTJ includes detecting the MTJ to be in:
a low resistance state in response to a magnetization of the free layer being in the first magnetization direction, an angle between the first magnetization direction and a magnetization direction of the reference layer being smaller than 90° and larger than or equal to 0°, and
a high resistance state, in which a resistance of the MTJ is higher than in the low resistance state, in response to the magnetization of the free layer being in the second magnetization direction, an angle between the second magnetization direction and the magnetization direction of the reference layer being larger than 90° and smaller than or equal to 180°.
